(19) United States
(12) Patent Application Publication
(10) Pub. No.: US 2008/0218678 A1
(43) Pub. Date: Sep. 11, 2008

(54) LIQUID CRYSTAL DISPLAY DEVICE

(76) Inventors: Koji Nakayama, Kanazawa-shi (JP); Noriyuki Kizu, Hakusan-shi (JP); Kazuyuki Harada, Ishikawa-gun (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/037,430

(22) Filed: Feb. 26, 2008

(30) Foreign Application Priority Data
Mar. 9, 2007 (JP) 2007-060788
Jan. 28, 2008 (JP) 2008-016534

(51) Int. Cl. G02F 1/1343

(52) U.S. Cl. 349/147

(57) ABSTRACT

A power supply wiring which is disposed on an array substrate and supplies a predetermined potential to a counter-electrode, includes a power supply pad which is included in a third electrically conductive layer, a first wiring which is included in a first electrically conductive layer and is electrically connected to the power supply pad, a second wiring which is included in a second electrically conductive layer, and a bridge wiring which is included in the third electrically conductive layer and electrically connects the first wiring and the second wiring, the power supply wiring being electrically connected to the counter-electrode via an electrically conductive member which is disposed on the power supply pad.

### CROSS-REFERENCE TO RELATED APPLICATIONS

This application is based upon and claims the benefit of priority from prior Japanese Patent Applications No. 2007-060788, filed Mar. 9, 2007; and No. 2008-016534, filed Jan. 28, 2008, the entire contents of both of which are incorporated herein by reference.

### BACKGROUND OF THE INVENTION

1. Field of the Invention

The present invention relates generally to a liquid crystal display device, and more particularly to a structure for supplying power from a power supply wiring, which is disposed on an array substrate, to a counter-electrode which is disposed on a counter-substrate.

2. Description of the Related Art

A liquid crystal display device, which is a typical example of a flat-screen display device, includes a liquid crystal display panel that is constructed such that a liquid crystal layer is held between an array substrate and a counter-substrate which are attached to each other via a seal member. The liquid crystal display panel includes an active area that is composed of matrix-arrayed pixels. The array substrate includes, in the active area, a plurality of scanning lines which extend in a row direction of the pixels, a plurality of signal lines which extend in a column direction of the pixels, switching elements which are disposed near intersections of the scanning lines and signal lines, and pixel electrodes which are connected to the associated switching elements.

There have been proposed various power supply structures for supplying potential from the array substrate side to a counter-electrode which is disposed on the counter-substrate.

Jpn. Pat. Appln. KOKAI Publication No. 8-234220, for instance, proposes a power supply structure wherein a power supply wiring on the array substrate side and a counter-electrode on the counter-substrate side are connected via an electrically conductive member on an outside of a seal member.

### BRIEF SUMMARY OF THE INVENTION

The object of the present invention is to provide a liquid crystal display device with high reliability, which includes a power supply structure that is capable of enhancing electrostatic withstand voltage characteristics and exactly supplying power from a power supply wiring to a counter-electrode.

According to an aspect of the present invention, there is provided a liquid crystal display device comprising: an array substrate including a first electrically conductive layer, a second electrically conductive layer which is disposed on a first insulation layer covering the first electrically conductive layer, and a third electrically conductive layer which is disposed on a second insulation layer covering the second electrically conductive layer; a counter-substrate including a counter-electrode; a liquid crystal layer which is held in a gap between the array substrate and the counter-substrate; and a power supply wiring which is disposed on the array substrate along an outer periphery of an active area which displays an image, and supplies a predetermined potential to the counter-electrode, wherein the power supply wiring includes a power supply pad which is included in the third electrically conductive layer, a first wiring which is included in the first electrically conductive layer and is electrically connected to the power supply pad, a second wiring which is included in the second electrically conductive layer, and a bridge wiring which is included in the third electrically conductive layer and electrically connects the first wiring and the second wiring, the power supply wiring being electrically connected to the counter-electrode via an electrically conductive member which is disposed on the power supply pad.

The present invention can provide a liquid crystal display device with high reliability, which includes a power supply structure that is capable of enhancing electrostatic withstand voltage characteristics and exactly supplying power from a power supply wiring to a counter-electrode.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the structure of a liquid crystal display panel of a liquid crystal display device according to an embodiment of the present invention;

FIG. 2 schematically shows the cross-sectional structure of an active area in the liquid crystal display panel shown in FIG. 1;

FIG. 3 is a plan view showing the structure of a power supply wiring including a power supply section in the liquid crystal display panel shown in FIG. 1;

FIG. 4 is a cross-sectional view showing the structure of a power supply wiring on an array substrate side in the liquid crystal display panel shown in FIG. 3;

FIG. 5A is a plan view showing a first structure example of a power supply structure which is applicable to the liquid crystal display device according to the embodiment of the invention;

FIG. 5B is a cross-sectional view showing the structure of the power supply wiring on the array substrate side in the first structure example shown in FIG. 5A;

FIG. 6A is a plan view showing a second structure example of the power supply structure which is applicable to the liquid crystal display device according to the embodiment of the invention;

FIG. 6B is a cross-sectional view showing the structure of the power supply wiring on the array substrate side in the second structure example shown in FIG. 6A;

FIG. 7 is a plan view showing a third structure example of the power supply structure which is applicable to the liquid crystal display device according to the embodiment of the invention;

FIG. 8 is a plan view showing a fourth structure example of the power supply structure which is applicable to the liquid crystal display device according to the embodiment of the invention;

FIG. 9 is a plan view showing a fifth structure example of the power supply structure which is applicable to the liquid crystal display device according to the embodiment of the invention; and

FIG. 10 is a plan view showing a sixth structure example of the power supply structure which is applicable to the liquid crystal display device according to the embodiment of the invention.

### DETAILED DESCRIPTION OF THE INVENTION

A display device according to an embodiment of the present invention, in particular, a liquid crystal display device, will now be described with reference to the accompanying drawings.

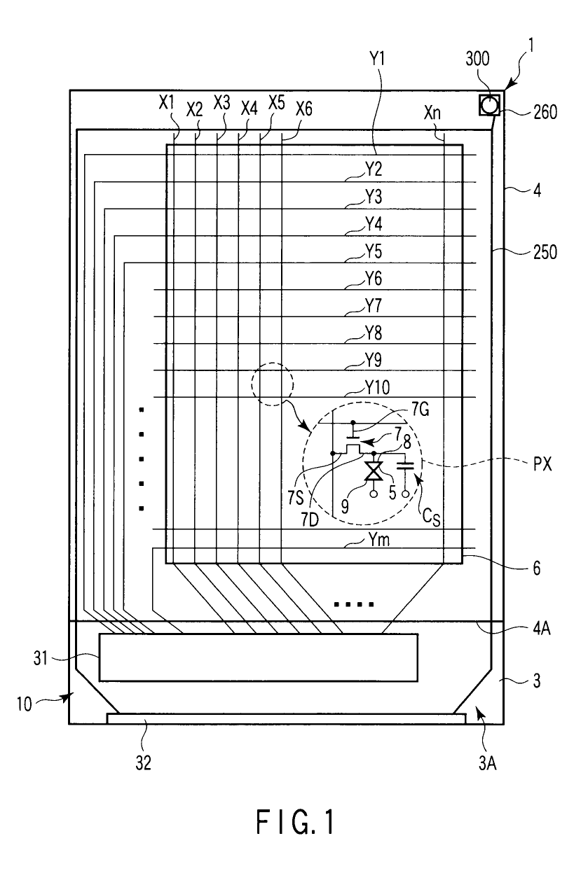

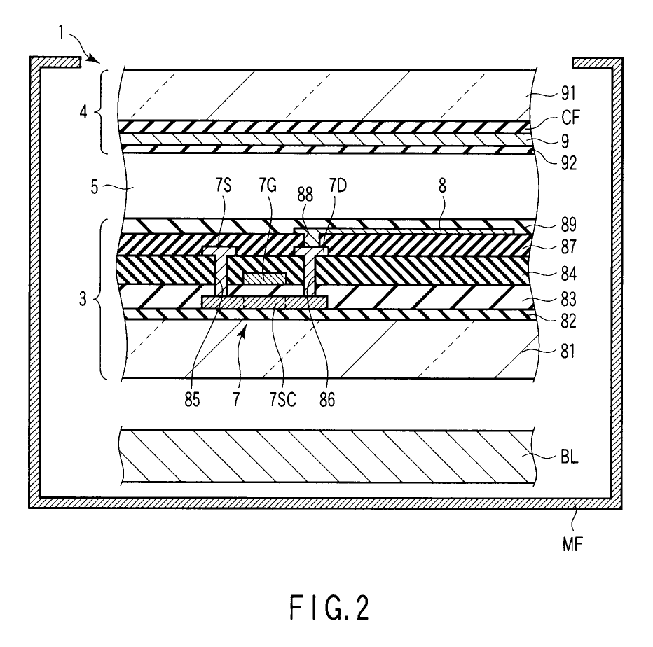

As shown in FIG. 1 and FIG. 2, a liquid crystal display device includes a substantially rectangular, flat liquid crystal display panel 1. The liquid crystal display panel 1 comprises a pair of electrode substrates having electrodes, that is, an array substrate 3 and a counter-substrate 4, and a liquid crystal layer 5 that is held between the array substrate 3 and counter-substrate 4. The array substrate 3 and counter-substrate 4 are attached to each other via a seal member in the state in which a predetermined gap for holding the liquid crystal layer 5 is created between the array substrate 3 and counter-substrate 4. The liquid crystal display panel 1 includes a substantially rectangular active area 6, which displays an image, within the region surrounded by the seal member. The active area 6 includes a plurality of pixels PX which are arrayed in a matrix, and a plurality of signal supply wiring lines which supply various signals that are necessary for driving the respective pixels PX.

The array substrate 3 is formed by using a light-transmissive insulating substrate 81 such as a glass substrate. On one major surface of the insulating substrate 81 (i.e. on the surface facing the liquid crystal layer 5) in the active area 6, the array substrate 3 includes, as signal supply wiring lines, a plurality of scanning lines Y (1, 2, 3, . . . , m) that extend in a row direction of the pixels PX, a plurality of signal lines X (1, 2, 3, . . . , n) that extend in a column direction of the pixels PX, and storage capacitance lines for forming storage capacitances Cs. The scanning lines Y and signal lines X are disposed on mutually different layers via an insulation layer. In addition, the array substrate 3 includes, in the active area 6, switching elements 7 that are arranged in areas including intersections of scanning lines Y and signal lines X in association with the respective pixels PX, and pixel electrodes 8 that are connected to the switching elements 7.

The switching element 7 is composed of, e.g. a thin-film transistor (TFT). The switching element 7 includes a semiconductor layer 7SC, a gate electrode 7G, a source electrode 7S and a drain electrode 7D.

The semiconductor layer 7SC is disposed on an undercoat layer 82 that covers the insulating substrate 81. The semiconductor layer 7SC is formed of, e.g. a polycrystalline silicon thin film or an amorphous silicon thin film. The undercoat layer 82 is formed of a silicon nitride film (Si₃N₄) or a silicon oxide film (SiO₂), for instance. The semiconductor layer 7SC is covered with a gate insulation film 83.

The gate electrode 7G is disposed on the gate insulation film 83. The gate electrode 7G is electrically connected to the associated scanning line Y (or formed integral with the scanning line Y). The gate insulation film 83 is formed of, e.g. a silicon oxide film. The gate electrode 7G is covered with an interlayer insulation film (a first insulation layer) 84.

The source electrode 7S and drain electrode 7D are disposed on the interlayer insulation film 84. The source electrode 7S is put in contact with a source region of the semiconductor layer 7SC via a contact hole 85 which penetrates the gate insulation film 83 and interlayer insulation film 84, and is electrically connected to the associated signal line X (or formed integral with the signal line X). The drain electrode 7D is put in contact with a drain region of the semiconductor layer 7SC via a contact hole 86 which penetrates the gate insulation film 83 and interlayer insulation film 84. The interlayer insulation film 84 is formed of, e.g. an inorganic material such as a silicon nitride film or a silicon oxide film. The source electrode 7S and drain electrode 7D are covered with a protection insulation film (a second insulation layer) 87. The protection insulation film 87 is formed of, e.g. an inorganic material such as a silicon nitride film or a silicon oxide film, or an organic material such as resin.

The pixel electrode 8 is disposed on the protection insulation film 87. The pixel electrode 8 is electrically connected to the drain electrode 7D via a contact hole 88 which penetrates the protection insulation film 87. In a transmissive liquid crystal display device, as shown in FIG. 2, which displays an image by selectively passing backlight from a backlight unit BL, the pixel electrode 8 is formed of a light-transmissive electrically conductive material such as indium tin oxide (ITO). On the other hand, in a reflective liquid crystal display device which displays an image by selectively reflecting ambient light that is incident from the counter-substrate 4 side or light from a front light unit, the pixel electrode 8 is formed of a light-reflective electrically conductive material such as aluminum (Al). The pixel electrode 8 is covered with an alignment film 89 for controlling alignment of liquid crystal molecules which are included in the liquid crystal layer 5.

The counter-substrate 4 is formed by using a light-transmissive insulating substrate 91 such as a glass substrate. In the active area 6, the counter-substrate 4 includes a counter-electrode 9, which is common to all the pixels PX, on one major surface of the insulating substrate 91 (i.e. the surface facing the liquid crystal layer 5). The counter-electrode 9 is formed of a light-transmissive electrically conductive material such as ITO. The counter-electrode 9 is covered with an alignment film 92 for controlling alignment of liquid crystal molecules which are included in the liquid crystal layer 5.

A color display type liquid crystal display device includes a color filter layer CF in association with each of the pixels. In the example shown in FIG. 2, the color filter layer CF is disposed between the insulating substrate 91 and counter-electrode 9 in the counter-substrate 4. The color filter layer CF is formed of resin materials which are colored in a plurality of colors, for example, in the three primary colors of red (R), green (G) and blue (B). The red color resin, green color resin and blue color resin are disposed in association with a red pixel, a green pixel and a blue pixel, respectively. The color filter layer CF may be disposed on the array substrate 3 side.

The array substrate 3 and counter-substrate 4 are disposed in the state in which the pixel electrodes 8 of the plural pixels PX are opposed to the counter-electrode 9, and a predetermined gap is formed between the array substrate 3 and counter-substrate 4 by a spacer not shown (e.g. a columnar spacer which is formed integral with one of the substrates). The liquid crystal layer 5 is formed of a liquid crystal composition which is sealed in the gap between the array substrate 3 and counter-substrate 4. In addition, the outer surfaces of the array substrate 3 and counter-substrate 4 are provided with optical elements including a pair of polarizer plates, whose directions of polarization are set in accordance with the characteristics of the liquid crystal layer 5.

The liquid crystal display panel 1 includes a first connection section 31 and a second connection section 32, which are disposed on an outer peripheral part 10 that is located outside the active area 6. The first connection part 31 includes a plurality of pads which are connectable to a driving IC chip which functions as a signal supply source. The second connection part 32 includes a plurality of terminals which are connectable to a flexible printed circuit (FPC) which functions as a signal supply source.

In the example shown in FIG. 1, the first connection part 31 and second connection part 32 are disposed on an extension part 3A of the array substrate 3, which extends outward from an end portion 4A of the counter-substrate 4. The scanning lines Y (1, 2, 3, . . . , m) and signal lines X (1, 2, 3, . . . , n), which are disposed in the active area 6, are led out to the outer peripheral part 10 and are connected to the first connection part 31.

In recent years, with a demand for reduction in thickness of the liquid crystal display panel 1, the thickness of the insulating substrates that constitute the liquid crystal display panel 1 has been decreasing more and more. Thus, in order to secure the strength of the module, the liquid crystal display panel 1 is reinforced with a metal frame MF, as shown in FIG. 2. The inventor has analyzed the factors of display defects which may occur in a case of performing a durability test against electrostatic discharge (ESD) in this module form.

The inventor has made various studies on this phenomenon. The inventor has found that when static electricity is applied from outside, electric charge reaches the side surface of the liquid crystal display panel 1 via the metal frame MF, and enters an electrically conductive layer of the array substrate 3, in particular, a power supply wiring 250 for supplying a predetermined potential (common potential) from the array substrate 3 side to the counter-electrode 9, and that this is a factor of occurrence of wire breakage. In particular, electric charge tends to easily enter a power supply section 260 in the power supply wiring 250, which is in contact with an electrically conductive member, since the power supply section 260 has an electrically conductive layer which is exposed to the surface of the array substrate 3 and extends up to the end portion of the substrate.

The power supply wiring 250 is disposed in a frame-like shape along the outer periphery of the active area 6. In particular, in the example shown in FIG. 1, the power supply wiring 250 extends substantially parallel to three sides so as to surround the rectangular active area 6, and the end portions of the power supply wiring 250 are connected to the second connection part 32. A part of the power supply wiring 250 extends to an end portion of the array substrate 3 and constitutes the power supply section 260. The power supply wiring 250 is electrically connected to the counter-electrode 9 via an electrically conductive member 300 that is in contact with the power supply section 260.

The structure of the power supply wiring 250 including the power supply section 260 will now be described in greater detail.

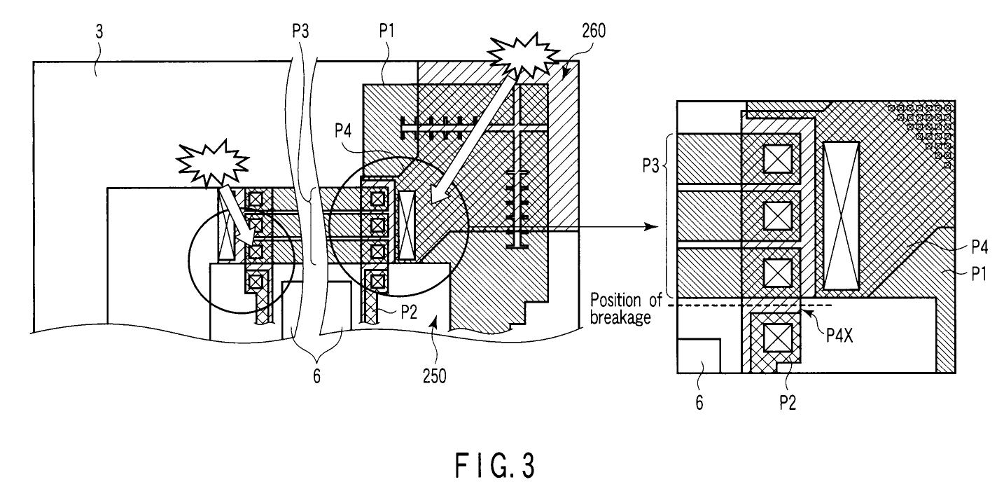

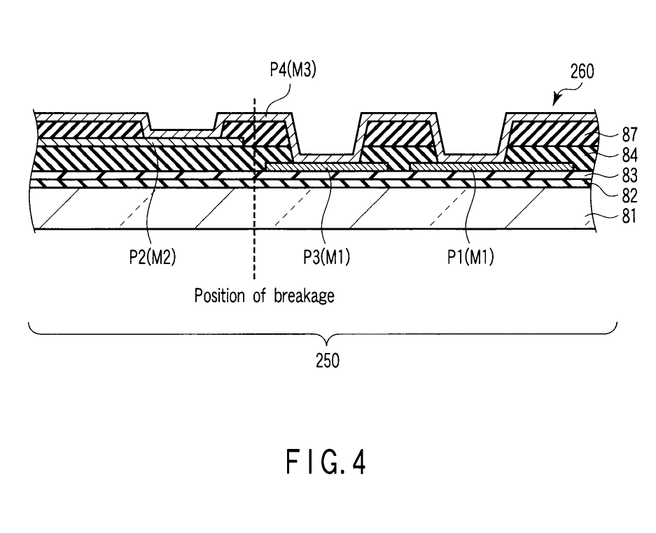

Specifically, as shown in FIG. 3 and FIG. 4, the array substrate 3 includes a first electrically conductive layer M1, a second electrically conductive layer M2 which is disposed on the interlayer insulation film 84 covering the first electrically conductive layer M1, and a third electrically conductive layer M3 which is disposed on the protection insulation film 87 covering the second electrically conductive layer M2. The first electrically conductive layer M1 is a layer including, e.g. scanning lines Y, and is formed of, e.g. molybdenum-tungsten (MoW). The second electrically conductive layer M2 is a layer including, e.g. signal lines X, and is formed of a multi-layer body of molybdenum (Mo)/aluminum (Al)/molybdenum (Mo). The third electrically conductive layer M3 is a layer including, e.g. pixel electrodes 8, and is formed of, e.g. ITO.

Attention is now paid to an upper right part of the liquid crystal display panel 1, at which the power supply section 260 is disposed. The power supply wiring 250 comprises a first wiring (first island pattern) P1 which is an underlayer of the power supply section 260 and extends substantially in parallel to the signal lines X; a second wiring (second island pattern) P2 which extends substantially in parallel to the signal lines X between the first wiring P1 and the active area 6; a third wiring (third island pattern) P3 which is spaced apart from the first wiring P1 and extends substantially in parallel to the scanning lines Y; and a fourth wiring (fourth island pattern) P4 which extends up to the end portion of the array substrate 3 and contacts and electrically connects the first wiring P1, second wiring P2 and third wiring P3.

The first wiring P1 and third wiring P3 are included in the first electrically conductive layer M1, and are formed of the same material as, for instance, the scanning lines Y. The second wiring P2 is included in the second electrically conductive layer M2 and is formed of the same material as, for instance, the signal lines X. The fourth wiring P4 is included in the third electrically conductive layer M3 and is formed of the same material as, for instance, the pixel electrodes 8. The fourth wiring P4 is exposed to the surface of the array substrate 3 and a part of the fourth wiring P4 functions as the power supply section 260. To form the power supply wiring 250 of a plurality of island patterns is important in reducing the capacitance as a countermeasure to static electricity, since the power supply wiring 250 is disposed over a relatively wide area.

In the power supply wiring 250 having the above-described structure, the static electricity that enters the fourth wiring P4 from the end portion of the array substrate 3 flows along the surface of the fourth wiring P4. The area of the fourth wiring P4 is relatively large at the power supply section 260 into which static electricity may easily enter, but the area of the fourth wiring P4 is relatively small at a connection part P4X between the second wiring P2 and third wiring P3. Owing to this configuration, charge may concentrate at the connection part P4X, leading to wire breakage. In addition, in a case of adopting such a structure that at an upper left part of the liquid crystal display panel 1, too, a plurality of island patterns are electrically connected by an island pattern included in the third electrically conductive layer M3, similar wire breakage may occur at a part where charge tends to easily concentrate.

The wire breakage of the fourth wiring P4 means wire breakage of the power supply wiring 250. A common potential, which is supplied from the second connection part 32, is not supplied to the power supply section 260, and this is a factor of the occurrence of a display defect.

Some examples of the power supply structure according to the present embodiment will now be described.

### FIRST STRUCTURE EXAMPLE

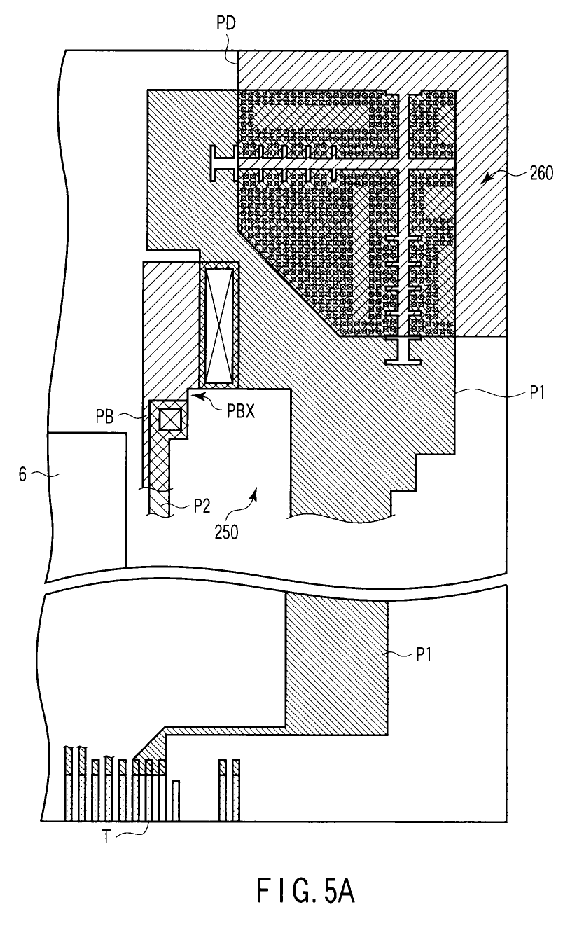

In a first structure example, as shown in FIG. 5A and FIG. 5B, a power supply wiring 250 comprises a first wiring P1, a second wiring P2 which is spaced apart from the first wiring P1, a power supply pad PD which extends to an end portion of the array substrate 3 and is electrically connected to the first wiring P1, and a bridge wiring PB which is spaced apart from the power supply pad PD, and contacts and electrically connects the first wiring P1 and second wiring P2.

The first wiring P1 is included in the first electrically conductive layer M1 and is formed of the same material as, for instance, the scanning lines Y. The first wiring P1 extends substantially in parallel to the signal lines X. Preferably, the first wiring P1 should extend to a terminal T in the second connection part 32.

The second wiring P2 is included in the second electrically conductive layer M2 and is formed of the same material as, for instance, the signal lines X. The second wiring P2 extends substantially in parallel to the signal lines X between the first wiring P1 and active area 6. The second wiring P2 is a wiring for supplying a predetermined potential, e.g. a common potential, to the pixels in the active area 6.

The power supply pad PD and bridge wiring PB are included in the third electrically conductive layer M3 and is formed of the same material as, for instance, the pixel electrodes 8. The power supply pad PD is put in contact with the first wiring P1 via a contact hole which is formed in the interlayer insulation film 84 and protection insulation film 87. The power supply pad PD is exposed to the surface of the array substrate 3 and functions as the above-described power supply section 260. The bridge wiring PB is put in contact with the first wiring P1 via a contact hole which is formed in the interlayer insulation film 84 and protection insulation film 87, and is also put in contact with the second wiring P2 via a contact hole which is formed in the protection insulation film 87.

The power supply wiring 250 is electrically connected to the counter-electrode via an electrically conductive member which is disposed on the power supply pad PD. In the power supply wiring 250 having the above-described structure, static electricity, which enters the power supply pad PD from the end portion of the array substrate 3, flows along the surface of the power supply pad PD. At this time, since the power supply pad PD and bridge wiring PB, which are formed in the same layer, are spaced apart, it is possible to suppress direct concentration of a great quantity of charge on a connection part PBX between the first wiring P1 and second wiring P2 in the bridge wiring PB. In other words, the charge, which has entered the power supply pad PD, flows into the first wiring P1 and is dispersed, and then part of the charge flows into the second wiring P2 via the bridge wiring PB.

Since the charge can be dispersed as described above, it is possible to suppress wire breakage of the power supply wiring 250. Hence, the electrostatic withstand voltage characteristics of the power supply wiring 250 can be improved, and power can exactly be supplied from the power supply wiring 250 to the counter-electrode 9. Therefore, the occurrence of display defects can be prevented, and a liquid crystal display device with high reliability can be provided.

It is considered that the above-described wire breakage of the connection part P4X occurs for the reason that charge concentrates on the connection part P4X due to the relatively narrow area of the connection part P4X between the second wiring P2 and third wiring P3. The connection part P4X becomes narrow due to the small width of the second wiring P2 and third wiring P3.

In the present structure example, wire breakage does not occur due to concentration of charge on the connection part PBX. Thus, the width of the second wiring P2 and third wiring P3 can be reduced, and the area of these wirings can be decreased. Therefore, in the present structure example, the reliability can be enhanced and the picture frame size can be reduced.

With the structure wherein the first wiring P1 extends to the terminal T, charge can be guided to the signal supply source side via the second connection part 32.

The power supply section 260, which contacts the electrically conductive member 300, has such a problem that metal corrosion may easily occur since the power supply section 260 is a part that is located at the end portion of the array substrate 3 and is exposed to the surface. On the other hand, an indium-oxide-based metal, such as ITO, which is used for the power supply pad and is the same material as the material of the pixel electrodes, has such characteristics that corrosion does not easily occur. Hence, the first electrically conductive layer M1 can be made to have corrosion-inhibiting properties by coating the first electrically conductive layer M1, which is formed of a corrosion-prone metal, with, e.g. ITO.

Thus, in the power supply section 260 of each of the present structure example and the structure examples to be described below, the first wiring P1 is not exposed and is prevented from corrosion by connecting the electrically conductive member 300 to the first wiring P1 via the third electrically conductive layer M3 which is formed of, e.g. ITO. In other words, from the standpoint of corrosion, the electrically conductive member 300 should preferably be prevented from directly contacting the first wiring P1. In the structure examples, the third electrically conductive layer M3 can be realized without increasing the number of process steps, since the third electrically conductive layer M3 is formed in the same step as the formation of pixel electrodes.

### SECOND STRUCTURE EXAMPLE

In the description of second and following structure examples, the same structural parts are denoted by like reference numerals, and a detailed description thereof is omitted.

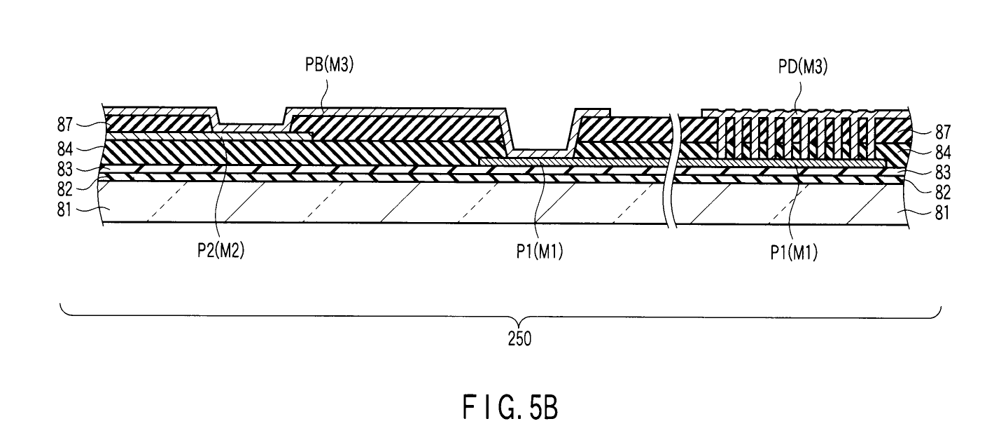

In the second structure example, as shown in FIG. 6A and FIG. 6B, a power supply wiring 250 comprises a first wiring P1 which extends substantially in parallel to the signal lines X, a second wiring P2 which extends substantially parallel to the signal lines X between the first wiring P1 and the active area 6, a third wiring P3 which is spaced apart from the first wiring P1 and extends substantially in parallel to the scanning lines Y, a power supply pad PD which extends to an end portion of the array substrate 3 and is electrically connected to the first wiring P1, and a bridge wiring PB which is spaced apart from the power supply pad PD, and contacts and electrically connects the first wiring P1, second wiring P2 and third wiring P3.

In the second structure example, a pair of second wirings P2 are disposed on both sides of the active area 6, and the third wiring P3 electrically connects the pair of second wirings P2. Thereby, a predetermined potential, e.g. a common potential, can be supplied to the respective pixels from both sides of the active area 6.

The first wiring P1 and third wiring P3 are included in the first electrically conductive layer M1. The second wiring P2 is included in the second electrically conductive layer M2. The power supply pad PD and bridge wiring PB are included in the third electrically conductive layer M3.

The power supply pad PD is put in contact with the first wiring P1 via a contact hole which is formed in the interlayer insulation film 84 and protection insulation film 87. The power supply pad PD is exposed to the surface of the array substrate 3 and functions as the above-described power supply section 260. The bridge wiring PB is put in contact with the first wiring P1 via a contact hole which is formed in the interlayer insulation film 84 and protection insulation film 87, is put in contact with the third wiring P3 via a contact hole which is formed in the interlayer insulation film 84 and the protection insulation film 87, and is also put in contact with the second wiring P2 via a contact hole which is formed in the protection insulation film 87.

The power supply wiring 250 is electrically connected to the counter-electrode via an electrically conductive member which is disposed on the power supply pad PD. In the power supply wiring 250 having the above-described structure, electric charge, which enters the power supply pad PD, flows in the first wiring P1 and is dispersed, and part of the charge flows into the second wiring P2 and third wiring P3 via the bridge wiring PB. It is thus possible to suppress direct concentration of a great quantity of charge on a connection part PBX between the second wiring P2 and third wiring P3 in the bridge wiring PB. Since the charge can be dispersed, the same advantageous effects as in the first structure example can be obtained.

### THIRD STRUCTURE EXAMPLE

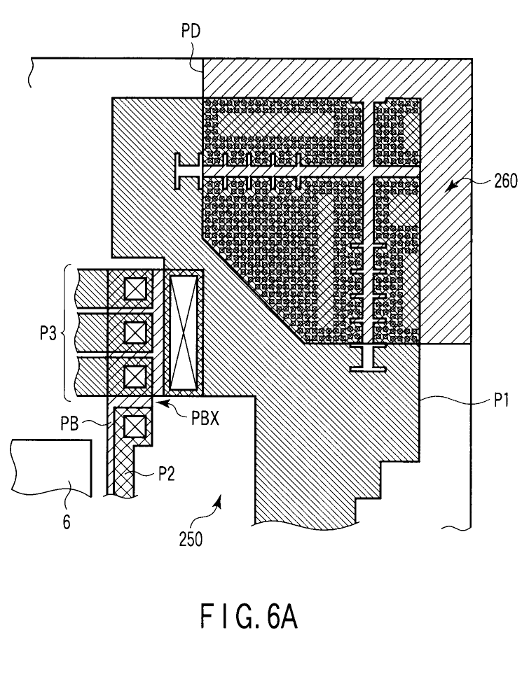

A third structure example, as shown in FIG. 7, differs from the preceding structure examples in that the third wiring P3 includes a plurality of segments and accordingly the bridge wiring PB includes a plurality of segments. The other patterns (first wiring, second wiring and power supply pad) that constitute the power supply wiring 250 are the same as those in the first structure example.

In the example shown in FIG. 7, the third wiring P3 includes a first segment P31, a second segment P32 and a third segment P33, which extend in plural lines substantially in parallel to the scanning lines Y. In the third wiring P3, the three segments P31 to P33 are included in the first electrically conductive layer M1, are formed of the same material as, e.g. the scanning lines Y, and are spaced apart from each other. The first segment P31 is farthest from the active area 6, the third segment P33 is closest to the active area 6, and the second segment P32 is disposed between the first segment P31 and third segment P33.

The bridge wiring PB includes a first segment PB1 which contacts and electrically connects the first wiring P1 and the first segment P31 of the third wiring P3; a second segment PB2 which contacts and electrically connects the first wiring P1 and the second segment P32; and a third segment PB3 which contacts and electrically connects the first wiring P1, the third segment P33 and the second wiring P2. In the bridge wiring PB, the three segments PB1 to PB3 are included in the third electrically conductive layer M3, are formed of the same material as, for instance, the pixel electrodes 8, and are spaced apart from each other.

In the power supply wiring 250 having the above-described structure, electric charge, which enters the power supply pad PD, flows in the first wiring P1 and is dispersed. Part of the charge flows into the first segment P31 of the third wiring P3 via the first segment PB1 of the bridge wiring PB, and similarly flows into the segment P32 via the second segment PB2, and into the second wiring P2 via the third segment PB3 and the third segment P33.

Thus, in the third structure example, the same advantageous effects as in the first structure example can, of course, be obtained, and the charge can be more dispersed than in the first structure example. Furthermore, the amount of charge, which flows into the inner segment (third segment) near the active area 6, can be decreased.

### FOURTH STRUCTURE EXAMPLE

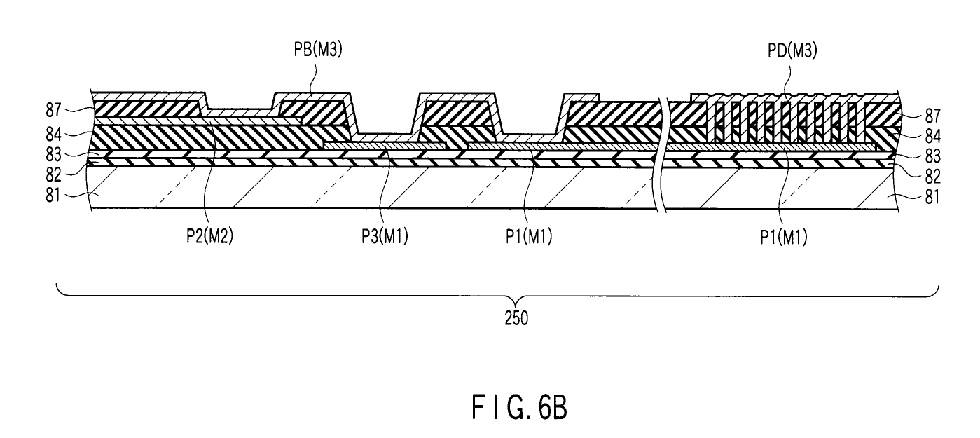

A fourth structure example, as shown in FIG. 8, differs from the above-described preceding structure examples in that a fourth wiring P4 including a power supply pad PD is disposed along an outer periphery of the array substrate 3 and extends to the terminal T which is connected to the signal supply source.

In the example shown in FIG. 8, the third wiring P3 includes a first segment P31, a second segment P32 and a third segment P33, which extend in plural lines substantially in parallel to the scanning lines Y. In the third wiring P3, these three segments P31 to P33 are included in the first electrically conductive layer M1. The first segment P31 is disposed at a farthest position from the active area 6.

The bridge wiring PB includes a first segment PB1 which contacts and electrically connects the first wiring P1 and the second segment P32 of the third wiring P3; and a second segment PB2 which contacts and electrically connects the first wiring P1, the third segment P33 and the second wiring P2. In the bridge wiring PB, the two segments PB1 and PB2 are included in the third electrically conductive layer M3.

The fourth wiring P4 includes a power supply pad PD which contacts the first wiring P1 and extends substantially in parallel to the signal lines X so as to overlap the first wiring P1 via the interlayer insulation film 84 and protection insulation film 87. The fourth wiring P4 and first wiring P1 are electrically connected via a plurality of contact holes which penetrate the interlayer insulation film 84 and protection insulation film 87 at intermediate portions. A distal end portion of the fourth wiring P4 is connected to the terminal T of the second connection part 32.

The fourth wiring P4 contacts the first segment P31 of the third wiring P3 and extends substantially in parallel to the scanning lines Y so as to overlap the first segment P31. The fourth wiring P4 and first segment P31 are electrically connected via a plurality of contact holes which penetrate the interlayer insulation film 84 and protection insulation film 87 at intermediate portions. The fourth wiring P4 is included in the third electrically conductive layer M3.

The other patterns which constitute the power supply wiring 250 have the same structure as in the third structure example.

In the power supply wiring 250 having the above-described structure, when electric charge enters the power supply pad PD of the fourth wiring P4, the charge does not directly flow into the other patterns which are disposed more on the active area 6 side than the fourth wiring P4, and the charge can be guided to the signal supply source side via the second connection part 32. Therefore, wire breakage of the power supply wiring 250 can be prevented, and the same advantageous effects as in the first structure example can be obtained.

### FIFTH STRUCTURE EXAMPLE

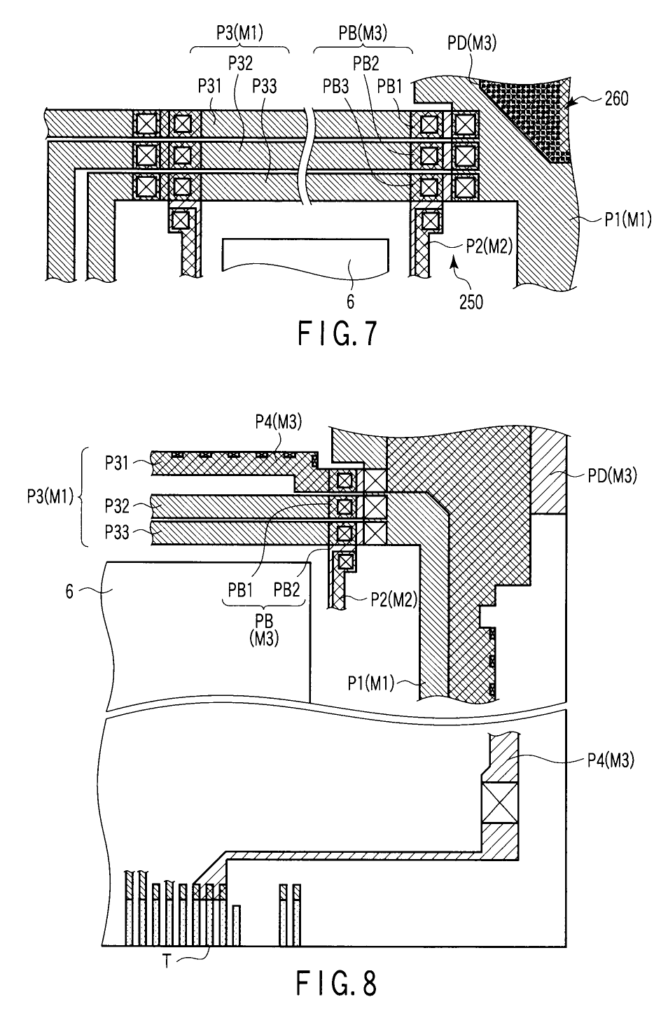

In a fifth structure example, as shown in FIG. 9, a power supply wiring 250 comprises a first wiring P1 which extends substantially in parallel to the signal lines X; a second wiring P2 which is disposed so as to surround the active area 6; a third wiring P3 which extends substantially in parallel to the scanning lines Y; a power supply pad PD which extends to the end portion of the array substrate 3 and contacts the first wiring P1; and a bridge wiring PB which contacts and electrically connects the first wiring P1, second wiring P2 and third wiring P3.

In the example shown in FIG. 9, the second wiring P2 is disposed more on the active area 6 side than the first wiring P1 and third wiring P3. Specifically, the second wiring P2 extends substantially in parallel to the signal lines X between the first wiring P1 and the active area 6, and extends substantially in parallel to the scanning lines Y between the third wiring P3 and the active area 6. The second wiring P2 is included in the second electrically conductive layer M2.

The third wiring P3 includes a first segment P31 which extends substantially in parallel to the scanning lines Y, and a second segment P32. The first segment P31 is disposed at a farthest position from the active area 6. The second segment P32 is disposed between the first segment P31 and the second wiring P2. In the third wiring P3, the two segments P31 and P32, like the first wiring P1, are included in the first electrically conductive layer M1.

The bridge wiring PB includes a first segment PB1 which contacts and electrically connects the first wiring P1 and the first segment P31 of the third wiring P3; and a second segment PB2 which contacts and electrically connects the first wiring P1 and the second segment P32; and a third segment PB3 which contacts and electrically connects the first wiring P1 and second wiring P2. In the bridge wiring PB, the two segments PB1 and PB2, like the power supply pad PD, are included in the third electrically conductive layer M3 and are spaced apart from the power supply pad PD.

In order to provide the second wiring P2 with redundancy, a portion of the second wiring P2, which extends substantially in parallel to the signal lines X, is made to overlap a fifth wiring P5 that is included in the third electrically conductive layer M3, and both are put in contact at plural locations. In addition, in order to impart redundancy to the second segment P32 and second wiring P2 which are substantially parallel to each other, the second segment P32 and second wiring P2 are put in contact at plural locations by a bridge pattern P6 which is included in the third electrically conductive layer M3.

The power supply pad PD may be formed integral with other patterns such as the first segment PB1 and second segment PB2 of the bridge wiring PB that is included in the third electrically conductive layer M3.

In the power supply wiring 250 having the above-described structure, electric charge, which enters the power supply pad PD, flows in the first wiring P1 and is dispersed. Part of the charge flows into the first segment P31 of the third wiring P3 via the first segment PB1 of the bridge wiring PB, and similarly flows into the second segment P32 via the second segment PB2, and into the second wiring P2 via the third segment PB3. Therefore, wire breakage of the power supply wiring 250 can be prevented, and the same advantageous effects as in the first structure example can be obtained.

### SIXTH STRUCTURE EXAMPLE

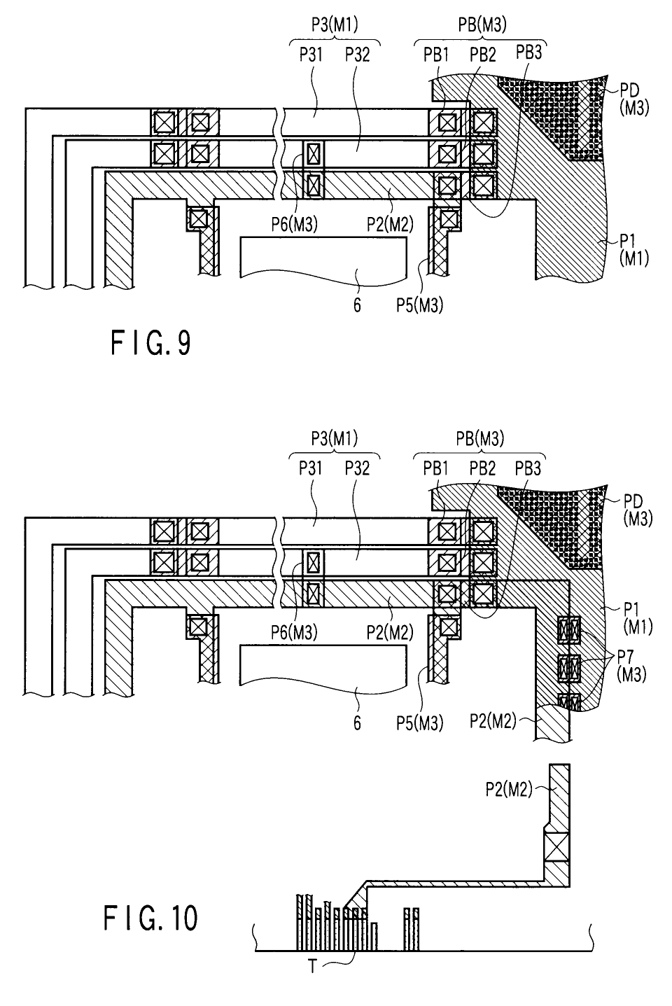

A sixth structure example, as shown in FIG. 10, differs from the fifth structure example in that at least a part of the second wiring P2 is disposed so as to overlap the first wiring P1 via the interlayer insulation layer 84, and extends to the terminal T which is connected to the signal supply source.

In the example shown in FIG. 10, the second wiring P2 extends substantially parallel to the signal lines X between the first wiring P1 and the active area 6, and extends substantially parallel to the scanning lines Y between the third wiring P3 and the active area 6. Further, the second wiring P2 is disposed so as to contact the first wiring P1, to extend substantially parallel to the signal lines X and to overlap the first wiring P1. A distal end portion of the second wiring P2 is connected to the terminal T of the second connection part 32. In order to provide the first wiring P1 and second wiring P2 with redundancy, the first wiring P1 and second wiring P2 are put in contact at plural locations by a bridge pattern P7 which is included in the third electrically conductive layer M3. The second wiring P2 is included in the second electrically conductive layer M2.

The other patterns which constitute the power supply wiring 250 have the same structure as in the fifth structure example.

In the power supply wiring 250 having the above-described structure, even if electric charge enters the power supply pad PD, wire breakage of the power supply wiring 250 can be prevented, the connection to the signal supply source can be secured via the second connection part 32, and a common potential can stably be supplied to the counter-electrode. Therefore, the same advantageous effect as in the first structure example can be obtained.

The present invention is not limited directly to the above-described embodiments. In practice, the structural elements can be modified without departing from the spirit of the invention. Various inventions can be made by properly combining the structural elements disclosed in the embodiments. For example, some structural elements may be omitted from all the structural elements disclosed in the embodiments. Furthermore, structural elements in different embodiments may properly be combined.

What is claimed is:

1. A liquid crystal display device comprising:
an array substrate including a first electrically conductive layer, a second electrically conductive layer which is disposed on a first insulation layer covering the first electrically conductive layer, and a third electrically conductive layer which is disposed on a second insulation layer covering the second electrically conductive layer;
a counter-substrate including a counter-electrode;
a liquid crystal layer which is held in a gap between the array substrate and the counter-substrate; and
a power supply wiring which is disposed on the array substrate along an outer periphery of an active area which displays an image, and supplies a predetermined potential to the counter-electrode,
wherein the power supply wiring includes a power supply pad which is included in the third electrically conductive layer, a first wiring which is included in the first electrically conductive layer and is electrically connected to the power supply pad, a second wiring which is included in the second electrically conductive layer, and a bridge wiring which is included in the third electrically conductive layer and electrically connects the first wiring and the second wiring, the power supply wiring being electrically connected to the counter-electrode via an electrically conductive member which is disposed on the power supply pad.

2. The liquid crystal display device according to claim 1, wherein the first wiring is disposed substantially parallel to a signal line in the active area, and extends to a terminal which is connected to a signal supply source.

3. The liquid crystal display device according to claim 1, wherein the second wiring is disposed between the active area and the first wiring.

4. The liquid crystal display device according to claim 1, wherein the power supply wiring further includes a third wiring which is included in the first electrically conductive layer and is disposed substantially parallel to a scanning line in the active area, and
the third wiring is electrically connected to the first wiring and the second wiring via the bridge wiring.

5. The liquid crystal display device according to claim 4, wherein the third wiring includes segments which are disposed in parallel in a plurality of lines, and
the bridge wiring includes a plurality of segments which are in contact with the first wiring and the segments of the third wiring.

6. The liquid crystal display device according to claim 1, wherein the power supply wiring includes a fourth wiring which is formed integral with the power supply pad and extends to a terminal which is connected to a signal supply source.

7. The liquid crystal display device according to claim 4, wherein the second wiring is disposed more on the active area side than the first wiring and the third wiring in such a manner as to surround the active area.

8. The liquid crystal display device according to claim 7, wherein the second wiring extends to a terminal which is connected to a signal supply source.
